(19) United States
(12) Patent Application Publication
(10) Pub. No.: US 2025/0379290 A1
(43) Pub. Date: Dec. 11, 2025

(54) NITROGEN BATTERY, FUEL SYNTHESIS APPARATUS, AND FUEL SYNTHESIS METHOD

(71) Applicant: KABUSHIKI KAISHA TOYOTA CHUO KENKYUSHO, Nagakute-shi (JP)

(72) Inventors: Nobuhiro OGIHARA, Nagakute-shi (JP); Hitoshi KUMAGAI, Nagakute-shi (JP); Ritsuko YAOKAWA, Nagakute-shi (JP)

(73) Assignee: KABUSHIKI KAISHA TOYOTA CHUO KENKYUSHO, Nagakute-shi (JP)

(21) Appl. No.: 19/033,685

(22) Filed: Jan. 22, 2025

(30) Foreign Application Priority Data
Feb. 20, 2024 (JP) 2024-023930
Oct. 30, 2024 (JP) 2024-190843

(51) Int. Cl. H01M 12/02; C01C 1/02; C01C 1/04; H01M 4/90; H01M 12/08

(52) U.S. Cl. CPC H01M 12/02; C01C 1/022; C01C 1/04; H01M 4/90; H01M 12/08

(57) ABSTRACT

The present invention relates to a nitrogen battery comprising:
a positive electrode using nitrogen as a positive electrode active material;
a negative electrode; and
an ion-conducting medium containing lithium bis(fluorosulfonyl)imide as at least a supporting electrolyte of the positive electrode, containing ether as a solvent present at least on the positive electrode side, and conducting alkali metal ions.

### BACKGROUND OF THE INVENTION

### Field of the Invention

The present invention relates to a nitrogen battery, a fuel synthesis apparatus, and a fuel synthesis method.

### Related Background Art

Nitrogen batteries using nitrogen as a positive electrode active material are expected to be high energy density batteries because the theoretical capacity density of nitrogen, calculated from the reduction reaction corresponding to the battery discharge, is extremely high at 5740 mAh/g.

As such a nitrogen battery, Chem, Apr. 13, 2017, Vol. 2, No. 4, pp. 525-532 (Non-Patent Document 1) proposes a battery that uses lithium metal as a negative electrode, places a non-aqueous electrolyte between the positive and negative electrodes, and performs a nitrogen reduction reaction at the positive electrode.

Additionally, Japanese Unexamined Patent Application Publication No. 2019-145370 (Patent Document 1) discloses a nitrogen battery comprising a positive electrode using nitrogen as a positive electrode active material, a negative electrode, and an ion-conducting medium containing a silane compound and conducting alkali metal ions, wherein Li(CF₃SO₂)₂N [LiTFSI] is used as the supporting electrolyte. However, the discharge voltage and electric capacity of these nitrogen batteries are not always sufficient. Patent Document 1 also discloses a fuel synthesis apparatus and a fuel synthesis method using the above-mentioned nitrogen battery; however, the fuel (ammonia) production efficiency of this apparatus and method was not always sufficient.

Nature Commun., 2012, Vol. 3, p. 1254 (Non-Patent Document 2) discloses a reduction reaction of nitrogen gas at ordinary temperature and ordinary pressure using an iron complex as a catalyst; in this reduction reaction, silylamine is synthesized by silylating nitrogen in the presence of an Fe catalyst, a silylating agent, and an alkali metal, and this silylamine is brought into contact with water to synthesize ammonia; as such, it is difficult to apply this reduction reaction to a nitrogen battery.

Furthermore, J. Phys. Chem. C, 2015, Vol. 119, pp. 6556-6567 (Non-Patent Document 3) discloses results of predictive analysis of whether a transition metal, which is the central metal of a metal-organic framework (MOF), functions as an adsorption site for O₂ or N₂, by calculating and comparing the interatomic distance between the transition metal M and oxygen atom O or nitrogen atom N and the interatomic distance between oxygen atoms of O₂ or nitrogen atoms of N₂ in a stable structure where O₂ or N₂ is arranged at the central transition metal in MOF, using first-principles calculations. These predictive analysis results show that, for example, when a 2,5-dihydroxyterephthalate of a transition metal M(M₂(dobdc)) is used as the MOF, the O—O interatomic distance in O₂ adsorbed to the transition metal M tends to increase compared to the O—O interatomic distance of non-adsorbed O₂ as the M-O interatomic distance decreases. This result suggests that a decrease in the bonding strength between oxygen atoms by M₂(dobdc) occurs in the reduction reaction of O₂, and predicts that M₂(dobdc) acts as a catalyst for the reduction reaction of Oz. On the other hand, Non-Patent Document 3 also shows the predictive analysis results that, in N₂ adsorbed to the transition metal M, even if the M-N interatomic distance decreases, the N—N interatomic distance hardly changes compared to the N—N interatomic distance of non-adsorbed N₂. This result suggests that a decrease in the bonding strength between nitrogen atoms by M₂(dobdc) does not occur in the reduction reaction of N₂, and predicts that M₂(dobdc) does not act as a catalyst for the reduction reaction of N₂.

### SUMMARY OF THE INVENTION

The present invention was made in view of the problems of the prior art, and its objective is to provide a nitrogen battery with high electric capacity and high energy density, and a fuel synthesis apparatus and fuel synthesis method capable of synthesizing ammonia with high efficiency.

The present inventors conducted extensive research to achieve the above objective and found that a nitrogen battery with a high discharge voltage (plateau voltage), high electric capacity, and high energy density can be obtained by using an ion-conducting medium that contains lithium bis(fluorosulfonyl)imide (LiFSI) as at least the supporting electrolyte of the positive electrode, contains ether as a solvent present at least on the positive electrode side, and conducts alkali metal ions; they further found that ammonia can be synthesized with high efficiency by using this nitrogen battery, thus completing the present invention.

That is, the present invention provides the following aspects.

[1] A nitrogen battery comprising a positive electrode using nitrogen as a positive electrode active material, a negative electrode, and an ion-conducting medium containing lithium bis(fluorosulfonyl)imide as at least a supporting electrolyte of the positive electrode, containing ether as a solvent present at least on a positive electrode side, and conducting alkali metal ions.

[2] The nitrogen battery according to [1], wherein the ether as the solvent present on the positive electrode side is a polyethylene glycol-based ether.

[3] The nitrogen battery according to [1] or [2], wherein the ion-conducting medium further contains a silane compound as an additive at least on the positive electrode side.

[4] The nitrogen battery according to any one of [1] to [3], wherein the ion-conducting medium includes a positive electrode-side ion-conducting medium present on the positive electrode side and in contact with the positive electrode and a negative electrode-side ion-conducting medium present on a negative electrode side and in contact with the negative electrode, the positive electrode-side ion-conducting medium contains lithium bis(fluorosulfonyl)imide as a supporting electrolyte of the positive electrode and contains ether as a solvent present on the positive electrode side, and the negative electrode-side ion-conducting medium contains lithium bis(fluorosulfonyl)imide as a supporting electrolyte of the negative electrode and contains ether as a solvent present on the negative electrode side.

[5] The nitrogen battery according to [4], wherein both the ether as the solvent present on the positive electrode side and the ether as the solvent present on the negative electrode side are polyethylene glycol-based ethers.

[6] The nitrogen battery according to any one of [1] to [5], wherein the positive electrode includes an electrode catalyst having immobilized transition metal ions.

[7] The nitrogen battery according to [6], wherein the electrode catalyst is a metal-organic framework containing transition metal ions and aromatic polycarboxylate ions.

[8] The nitrogen battery according to [7], wherein the transition metal ions are Fe ions, and the aromatic polycarboxylate ions are aromatic dicarboxylate ions represented by the following formula (1):

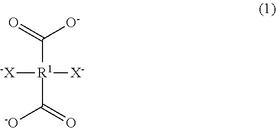

wherein R¹ represents a tetravalent organic group containing an aromatic ring, and X represents O or S.

[9] The nitrogen battery according to [8], wherein at least a part of the Fe ions are trivalent Fe ions.

[10] A fuel synthesis apparatus using the nitrogen battery according to any one of [1] to [9], which obtains as fuel ammonia generated by treating with water a nitrogen reduction reaction product obtained after operation of the nitrogen battery.

[11] A fuel synthesis method using the nitrogen battery according to any one of [1] to [9], comprising obtaining as fuel ammonia generated by treating with water a nitrogen reduction reaction product obtained after operation of the nitrogen battery.

The reason why a nitrogen battery with high electric capacity and high energy density can be obtained and ammonia can be synthesized with high efficiency by the present invention is not necessarily clear, but the present inventors speculate as follows. That is, it is speculated that in the nitrogen battery of the present invention, a coating derived from LiFSI is formed on the electrode catalyst by using an ion-conducting medium which contains LiFSI as at least a supporting electrolyte of the positive electrode and contains ether as a solvent present at least on the positive electrode side, and the nitrogen reduction reaction is promoted by the action of the electrode catalyst and the coating. It is also speculated that the use of an ion-conducting medium that contains LiFSI as at least the supporting electrolyte of the positive electrode and contains ether as a solvent present at least on the positive electrode side results in a high plateau voltage in the discharge reaction, during which the above-mentioned nitrogen reduction reaction is promoted, increasing the electric capacity and improving the ammonia production efficiency.

Further, the reason why a nitrogen battery with even higher electric capacity can be obtained and ammonia can be synthesized with even higher efficiency when the electrode catalyst is a metal-organic framework (MOF) containing Fe ions and the aromatic polycarboxylate ions represented by the formula (1) is not necessarily clear, but the present inventors speculate as follows. That is, the MOF containing Fe ions and the aromatic polycarboxylate ions represented by the formula (1) as the electrode catalyst has a hexagonal crystal structure as shown in FIG. 1. When such MOF is exposed to an oxygen atmosphere (for example, an air atmosphere), the Fe ions become trivalent. Since the Fe ions in the trivalent state become nitrogen adsorption sites (open metal sites), they easily adsorb nitrogen, and when electrons are donated through the MOF, the nitrogen adsorbed on the Fe ions is reduced even more efficiently by the above-mentioned cooperative electrochemical catalytic action of the coating and the MOF. As a result, it is presumed that the electric capacity is further increased, and ammonia can be synthesized with higher efficiency.

According to the present invention, a nitrogen battery having a high electric capacity and a high energy density can be obtained, and ammonia can be synthesized with high efficiency by using this nitrogen battery.

### BRIEF DESCRIPTION OF THE DRAWINGS

FIG. 1 is a schematic diagram showing the crystal structure of a metal-organic framework containing Fe ions and aromatic polycarboxylate ions represented by formula (1).

FIG. 2 is a schematic diagram showing an evaluation cell (nitrogen battery) produced in Examples and Comparative Examples.

FIG. 3 is a graph showing the relationship (discharge curve) between the electric capacity per unit mass of the electrode and the discharge voltage of the evaluation cell (nitrogen battery) produced in Example 1.

FIG. 4 is a graph showing the relationship (discharge curve) between the electric capacity per unit mass of the electrode and the discharge voltage of the evaluation cell (nitrogen battery) produced in Example 2.

FIG. 5 is a graph showing the relationship (discharge curve) between the electric capacity per unit mass of the electrode and the discharge voltage of the evaluation cell (nitrogen battery) produced in Example 3.

FIG. 6 is a graph showing the relationship (discharge curve) between the electric capacity per unit mass of the electrode and the discharge voltage of the evaluation cell (nitrogen battery) produced in Example 4.

FIG. 7 is a graph showing the relationship (discharge curve) between the electric capacity per unit mass of the electrode and the discharge voltage of the evaluation cell (nitrogen battery) produced in Example 5.

FIG. 8 is a graph showing the relationship (discharge curve) between the electric capacity per unit mass of the electrode and the discharge voltage of the evaluation cell (nitrogen battery) produced in Example 6.

FIG. 9 is a graph showing the relationship (discharge curve) between the electric capacity per unit mass of the electrode and the discharge voltage of the evaluation cell (nitrogen battery) produced in Example 7.

FIG. 10 is a graph showing the relationship (discharge curve) between the electric capacity per unit mass of the electrode and the discharge voltage of the evaluation cell (nitrogen battery) produced in Comparative Example 1.

FIG. 11 is a graph showing the relationship (discharge curve) between the electric capacity per unit mass of the electrode and the discharge voltage of the evaluation cell (nitrogen battery) produced in Comparative Example 2.

FIG. 12 is a graph showing the relationship (discharge curve) between the electric capacity per unit mass of the electrode and the discharge voltage of the evaluation cell (nitrogen battery) produced in Comparative Example 3.

FIG. 13 is a graph showing the relationship (discharge curve) between the electric capacity per unit mass of the electrode and the discharge voltage of the evaluation cell (nitrogen battery) produced in Comparative Example 4.

FIG. 14 is a graph showing the relationship (discharge curve) between the electric capacity per unit mass of the electrode and the discharge voltage of the evaluation cell (nitrogen battery) produced in Comparative Example 5.

FIG. 15 is a graph showing the relationship (discharge curve) between the electric capacity per unit mass of the electrode and the discharge voltage of the evaluation cell (nitrogen battery) produced in Comparative Example 6.

FIG. 16 is a graph showing the relationship (discharge curve) between the electric capacity per unit mass of the electrode and the discharge voltage of the evaluation cell (nitrogen battery) produced in Example 8.

FIG. 17 is a graph showing the relationship (discharge curve) between the electric capacity per unit mass of the electrode and the discharge voltage of the evaluation cell (nitrogen battery) produced in Example 9.

FIG. 18 is a graph showing the relationship (discharge curve) between the electric capacity per unit mass of the electrode and the discharge voltage of the evaluation cell (nitrogen battery) produced in Example 10.

FIG. 19 is a graph showing the relationship (discharge curve) between the electric capacity per unit mass of the electrode and the discharge voltage of the evaluation cell (nitrogen battery) produced in Example 11.

FIG. 20 is a graph showing the electric capacity per unit mass of the electrode up to a discharge voltage of 1.0 V of the evaluation cells (nitrogen batteries) produced in Examples 1 to 7 and Comparative Examples 1 to 6.

FIG. 21 is a graph showing the energy density up to a discharge voltage of 1.0 V of the evaluation cells (nitrogen batteries) produced in Examples 1 to 7 and Comparative Examples 1 to 6.

FIG. 22 is a graph showing the electric capacity per unit mass of the electrode up to a discharge voltage of 1.0 V under a nitrogen or argon atmosphere of the evaluation cells (nitrogen batteries) produced in Examples 8 to 11.

FIG. 23 is a graph showing the amount of ammonium ions produced up to a discharge voltage of 1.0 V of the evaluation cells (nitrogen batteries) produced in Examples 1 to 7 and Comparative Examples 1 to 6.

FIG. 24 is a graph showing the amount of ammonium ions produced up to a discharge voltage of 1.0 V under a nitrogen or argon atmosphere of the evaluation cells (nitrogen batteries) produced in Examples 8 to 11.

FIG. 25 is a graph showing the Fe K-edge XAFS spectrum of the positive electrode catalyst after the discharge test of Example 8.

FIG. 26 is a graph showing the Ni K-edge XAFS spectrum of the positive electrode catalyst after the discharge test of Example 9.

FIG. 27 is a graph showing the Co K-edge XAFS spectrum of the positive electrode catalyst after the discharge test of Example 10.

FIG. 28 is a graph showing the Mn K-edge XAFS spectrum of the positive electrode catalyst after the discharge test of Example 11.

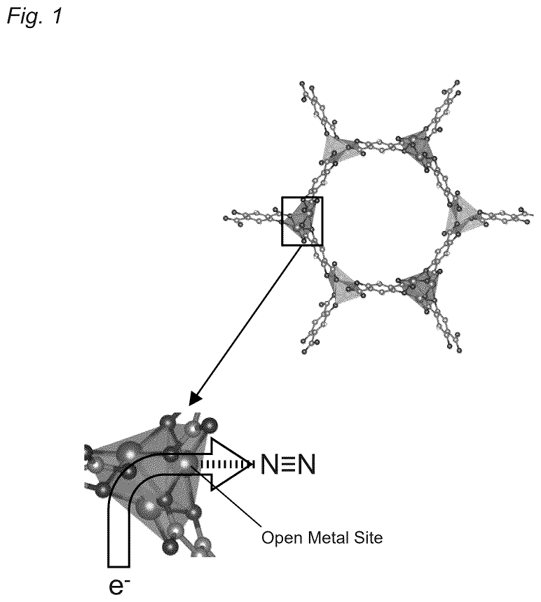

### DETAILED DESCRIPTION OF THE PREFERRED EMBODIMENTS

The present invention will be described in detail below based on its preferred embodiments.

### [Nitrogen Battery]

First, the nitrogen battery of the present invention will be described. The nitrogen battery of the present invention comprises a positive electrode using nitrogen as a positive electrode active material, a negative electrode, and an ion-conducting medium that contains lithium bis(fluorosulfonyl)imide as at least the supporting electrolyte of the positive electrode, contains ether as a solvent present at least on the positive electrode side, and conducts alkali metal ions.

### (Positive Electrode)

The positive electrode used in the present invention uses gaseous nitrogen as the positive electrode active material. The gaseous nitrogen may be contained in air or may be nitrogen gas. The positive electrode may also contain a conductive material and a conductive auxiliary agent. For example, it may be formed by press-molding an electrode mixture of a conductive material and a conductive auxiliary agent with a binder or the like into an arbitrary thickness and shape on a current collector (e.g., by pressing a kneaded product of the electrode mixture onto a mesh current collector), or it may be formed by applying a mixture of a conductive material, a conductive auxiliary agent and a binder or the like with a solvent to a current collector in an arbitrary thickness and shape. The shape of the positive electrode is preferably such that it has a uniform interface between the gaseous nitrogen and the ion-conducting medium, and is preferably, for example, porous or mesh-like.

The conductive material and the conductive auxiliary agent are not particularly limited as long as they are materials having conductive property, and examples thereof include carbon, conductive fibers, metal powders, and organic conductive materials. Examples of the carbon include carbon blacks such as Ketjenblack, acetylene black, channel black, furnace black, lamp black, and thermal black; graphites such as natural graphite such as flake graphite, artificial graphite, and expanded graphite; activated carbons using charcoal, coal, etc., as raw materials; carbon fibers obtained by carbonizing synthetic fibers, petroleum pitch-based raw materials, etc., and carbon paper. Examples of the conductive fibers include metal fibers. Examples of the metal powder include nickel powder and aluminum powder. Examples of the organic conductive material include polyphenylene derivatives. These conductive materials and conductive auxiliary agents may be used singly or in combination of two or more. As the positive electrode containing such a conductive material and a conductive auxiliary agent, a carbon-based electrode is preferable, and a carbon-based porous electrode is more preferable.

The binder plays a role in holding the conductive material and the conductive auxiliary agent in the positive electrode. Examples of such a binder include fluorine-containing resins such as polytetrafluoroethylene (PTFE), polyvinylidene fluoride (PVdF), and fluorine rubber; thermoplastic resins such as polypropylene, polyethylene, and polyacrylonitrile; rubbers such as ethylene propylene diene monomer (EPDM) rubber, sulfonated EPDM rubber, natural butyl rubber (NBR), and styrene-butadiene rubber (SBR); and water-soluble binders such as cellulose. These binders may be used singly or in combination of two or more. The binder may be added to a solvent as it is or may be mixed with a solvent as a dispersion. The blending amount of the binder is preferably 3 to 15% by mass relative to the total amount of the electrode mixture. When the blending amount of the binder is the lower limit or more, the strength of the positive electrode can be sufficiently maintained, while when the blending amount of the binder is the upper limit or less, the amounts of the conductive material, the conductive auxiliary agent, and the electrode catalyst described later do not become too small, and the progress of the electrode reaction is not easily hindered.

Examples of the solvent for dispersing the conductive material, the conductive auxiliary agent, and the binder include organic solvents such as N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, tetrahydrofuran, and alcohols (e.g., ethanol). These organic solvents may be used singly or in combination of two or more. Alternatively, a dispersant, a thicker, or the like may be added to water, and the conductive material, the conductive auxiliary agent, and the binder may be slurried with a latex such as SBR. Examples of the thicker include polysaccharides such as carboxymethyl cellulose and methyl cellulose.

Examples of the method of applying the mixture of the conductive material, the conductive auxiliary agent, and the binder or the like with the solvent to the current collector include roller coating using an applicator roll or the like, screen coating, doctor blade method, spin coating, and bar coating.

Examples of the current collector include metal current collectors such as stainless steel, nickel, and aluminum. The shape of the current collector is preferably porous, such as net-like or mesh-like, in order to promote nitrogen diffusion. The surface of the current collector may be coated with a film of an oxidation-resistant metal or alloy to suppress oxidation. The current collector may also be a single layer or a stacked layer of a transparent conductive material such as InSnO₂, SnO₂, ZnO, and In₂O₃ or a material doped with impurities such as fluorine-doped tin oxide (SnO₂:F), antimony-doped tin oxide (SnO₂:Sb), tin-doped indium oxide (In₂O₃:Sn), aluminum-doped zinc oxide (ZnO:Al), and gallium-doped zinc oxide (ZnO:Ga) formed on glass or a polymer. The film thickness of the material doped with impurities is not particularly limited, but is preferably 3 nm or more and 10 μm or less. The glass or polymer may have a smooth surface or may have irregularities.

The positive electrode used in the present invention preferably comprises an electrode catalyst having immobilized transition metal ions, from the viewpoint of increasing the electric capacity and energy density. The content of the electrode catalyst is preferably 10 to 50% by mass relative to the entire positive electrode. The transition metal is preferably one capable of reducing nitrogen, such as Sc, Ti, V, Cr, Mn, Fe, Co, Ni, Cu, Zn, Mo, Ru, Be and Mg, is more preferably a divalent transition metal such as Fe, Co, Ni, and Mn, and from the viewpoint that by exposing the electrode catalyst to an oxygen atmosphere (e.g., an air atmosphere), the valence of the transition metal becomes close to trivalent, the nitrogen reducing power increases, and the electric capacity and the amount of ammonia produced increase, is particularly preferably Fe. These transition metals may be used singly or in combination of two or more.

The electrode catalyst is more preferably a metal-organic framework (MOF) containing the transition metal ions and aromatic carboxylate ions, from the viewpoint that it is hardly dissolved in a non-aqueous electrolytic solution and is easily immobilized on the positive electrode. Examples of the aromatic carboxylate ions include aromatic dicarboxylate ions represented by the following formula (1):

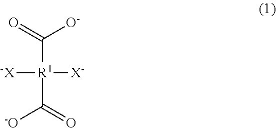

wherein R¹ represents a tetravalent organic group containing an aromatic ring, and X represents O or S, and aromatic tricarboxylate ions represented by the following formula (2):

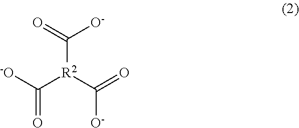

wherein R² represents a trivalent organic group containing an aromatic ring.

Examples of R¹ in the formula (1) include tetravalent organic groups containing an aromatic ring represented by the following formulas (1a) to (1f):

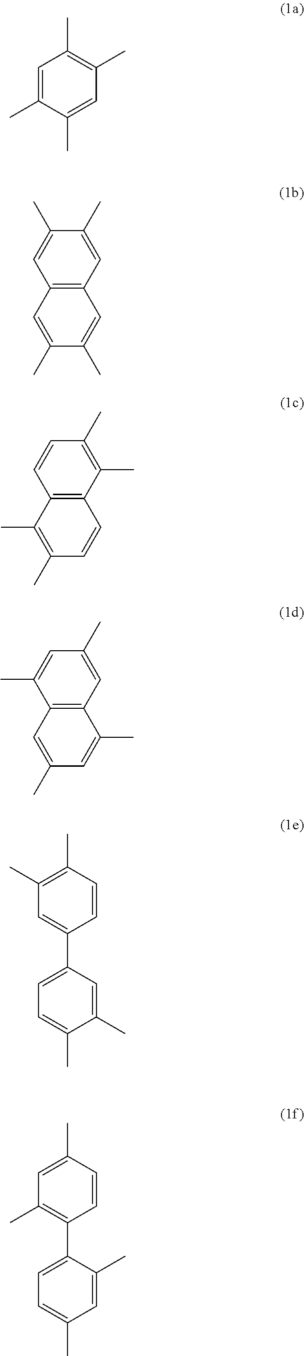

Examples of R² in the formula (2) include trivalent organic groups containing an aromatic ring represented by the following formulas (2a) and (2b):

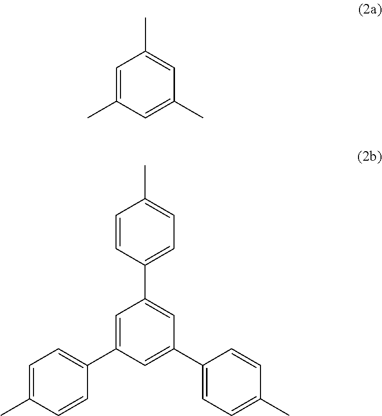

Specific examples of the aromatic dicarboxylate ions represented by the formula (1) include 2,5-dioxidoterephthalate ion represented by the following formula (3a), 2,5-disulfidoterephthalate ion represented by the following formula (3b), 3,7-dioxidonaphthalene-2,6-dicarboxylate ion represented by the following formula (4a), 1,5-dioxidonaphthalene-2,6-dicarboxylate ion represented by the following formula (4b), 3,3′-dioxido-[1,1′-biphenyl]-4,4′-dicarboxylate ion represented by the following formula (5a), and 4,4′-dioxido-[1,1′-biphenyl]-3,3′-dicarboxylate ion represented by the following formula (5b).

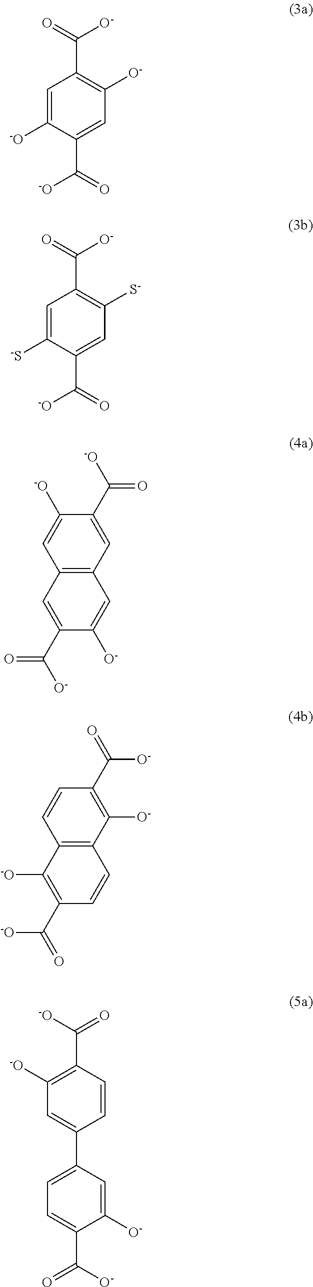

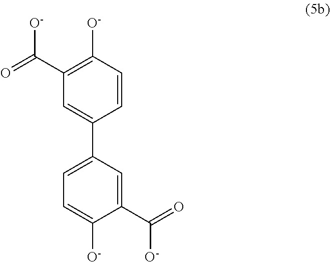 [SMILES: O=C([O-])c1cc(-c2ccc([O-])c(C(=O)[O-])c2)ccc1[O-]]

Specific examples of the aromatic tricarboxylate ions represented by the formula (2) include 1,3,5-benzenetricarboxylate ion represented by the following formula (6a) and the aromatic tricarboxylate ion represented by the following formula (6b).

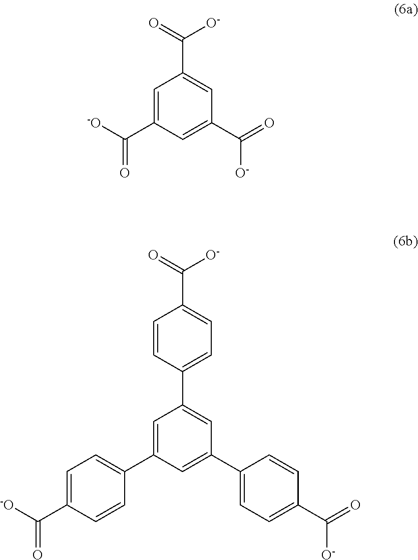

Examples of the metal-organic framework include metal-organic frameworks represented by the formula: M₂A [wherein M represents a divalent transition metal ion, and A represents the aromatic dicarboxylate ion represented by the formula (1)] and the formula: M₂B₃ [wherein M represents a divalent transition metal ion, and B represents the aromatic tricarboxylate ion represented by the formula (2)].

Among such metal-organic frameworks, a metal-organic framework containing Fe ions and the aromatic dicarboxylate ions represented by the formula (1) is preferred, and a metal-organic framework containing Fe ions and at least one of the aromatic dicarboxylate ions represented by the formulas (3a) to (5b) is more preferred, and a metal-organic framework containing Fe ions and the aromatic dicarboxylate ions represented by the formula (3a) is particularly preferred, from the viewpoint that the electric capacity, energy density, and the amount of ammonium ions produced are further increased. In these metal-organic frameworks, at least a part of the Fe ions are preferably trivalent Fe ions, from the viewpoint that the electric capacity, energy density, and the amount of ammonium ions produced are further increased. Such trivalent Fe ions can be generated by exposing the metal-organic framework to an oxygen atmosphere (e.g., an air atmosphere).

### (Negative Electrode)

The negative electrode used in the present invention is an electrode facing the positive electrode, and is not particularly limited as long as it can be used in a nitrogen battery; for example, a negative electrode containing a negative electrode active material capable of storing and releasing alkali metal ions (more preferably lithium ions) is preferred. Examples of the negative electrode active material capable of storing and releasing lithium ions include alkali metals (e.g., lithium, sodium, potassium), alkali metal alloys (e.g., lithium alloys), metal oxides, metal sulfides, and carbonaceous materials that store and release lithium. Examples of the lithium alloys include alloys of lithium with aluminum, tin, magnesium, indium, calcium, or the like. Examples of the metal oxides include tin oxide, silicon oxide, lithium titanium oxide, niobium oxide, and tungsten oxide. Examples of the metal sulfides include tin sulfide and titanium sulfide. Examples of the carbonaceous material that stores and releases lithium include graphite, coke, mesophase pitch-based carbon fiber, spherical carbon, and resin-baked carbon.

### (Ion-Conducting Medium)

The ion-conducting medium used in the present invention conducts alkali metal ions (preferably lithium ions), contains lithium bis(fluorosulfonyl)imide [LiFSI] as at least the supporting electrolyte of the positive electrode, and contains ether as a solvent present at least on the positive electrode side. Examples of such an ion-conducting medium include one containing a positive electrode-side ion-conducting medium which is present on the positive electrode side and in contact with the positive electrode, contains LiFSI as the supporting electrolyte of the positive electrode, and contains ether as the solvent present on the positive electrode side. The electric capacity and energy density increase because the ion-conducting medium contains LiFSI as at least the supporting electrolyte of the positive electrode (for example, the ion-conducting medium includes a positive electrode-side ion-conducting medium containing LiFSI as the supporting electrolyte of the positive electrode). The amount of ammonium ions produced increases because the ion-conducting medium contains ether as a solvent present at least on the positive electrode side (for example, the ion-conducting medium includes a positive electrode-side ion-conducting medium containing ether as the solvent present on the positive electrode side). From the viewpoint of increasing the electric capacity and energy density, the concentration of LiFSI in the positive electrode-side ion-conducting medium is preferably 0.1 to 3.0 mol/L, more preferably 0.5 to 2.0 mol/L, and even more preferably 0.5 to 1.0 mol/L. From the viewpoint of increasing the amount of ammonium ions produced, the ion-conducting medium and the positive electrode-side ion-conducting medium are preferably non-aqueous electrolytic solutions.

The ether as the solvent present on the positive electrode side is preferably a polyethylene glycol-based ether, and examples of the polyethylene glycol-based ether include polyethylene glycol monoalkyl ethers and polyethylene glycol dialkyl ethers. These polyethylene glycol-based ethers may be used singly or in combination of two or more.

The reason why the amount of ammonium ions produced increases by using an ion-conducting medium containing LiFSI as at least the supporting electrolyte of the positive electrode and ether as a solvent present at least on the positive electrode side is not necessarily clear, but the present inventors speculate as follows. Here, a case where the ether as the solvent present on the positive electrode side is polyethylene glycol dimethyl ether will be described as an example. That is, LiFSI contained in the ion-conducting medium in contact with the positive electrode forms, by a reduction reaction at the positive electrode, as described below, a radical derived from LiFSI and a site in a state where Li cations and fluorine anions interact with each other:

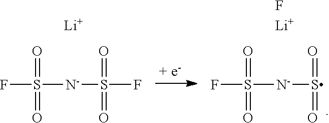

The radical derived from LiFSI reacts with polyethylene glycol dimethyl ether to form a stable combined product as follows:

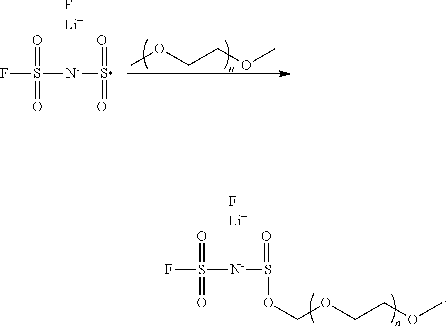

It is speculated that the site in a state where the Li cation and fluorine anion interact with each other exhibits catalytic activity for the nitrogen reduction reaction and catalytically promotes the nitrogen reduction reaction, thus increasing the amount of ammonium ions produced.

On the other hand, if an ion-conducting medium containing LiFSI as at least the supporting electrolyte of the positive electrode and a carbonate solvent as a solvent present at least on the positive electrode side is used, the LiFSI contained in the ion-conducting medium in contact with the positive electrode forms, similarly to the above, a radical derived from LiFSI and a site in a state where Li cations and fluorine anions interact with each other, by a reduction reaction at the positive electrode. However, since the radical derived from LiFSI does not react with the carbonate solvent and a stable combined product is not formed, it is presumed that the fluorine anion and the radical derived from LiFSI recombine to reduce the sites where the Li cation and fluorine anion interact with each other. As a result, it is presumed that the catalytic activity for the nitrogen reduction reaction decreases, and the nitrogen reduction reaction is not promoted, so that the amount of ammonium ions produced decreases. Alternatively, even if a combined product is formed by the reaction of a radical derived from LiFSI and a carbonate solvent, it is presumed that the sites where Li cations and fluorine anions interact with each other are not in a suitable state as a catalyst for the nitrogen reduction reaction (for example, catalytic activity is inhibited by the combined product). As a result, it is presumed that the catalytic activity for the nitrogen reduction reaction decreases, and the nitrogen reduction reaction is not promoted, so that the amount of ammonium ions produced decreases.

If an ion-conducting medium containing Li(CF₃SO₂)₂N [LiTFSI] as at least the supporting electrolyte of the positive electrode and ether as a solvent present at least on the positive electrode side is used, LiTFSI is stably present in a state represented by the following formula in the ion-conducting medium in contact with the positive electrode:

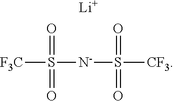 [SMILES: [Li+] ; O=S(=O)([N-]S(=O)(=O)C(F)(F)F)C(F)(F)F]

Therefore, it is presumed that radicals derived from LiTFSI are not generated, and sites where Li cations and fluorine anions interact with each other to exhibit catalytic activity for the nitrogen reduction reaction are not generated. For this reason, it is presumed that the nitrogen reduction reaction is not promoted and the amount of ammonium ions produced decreases.

When the ion-conducting medium used in the present invention includes the positive electrode-side ion-conducting medium, the ion-conducting medium preferably includes a negative electrode-side ion-conducting medium which is present on the negative electrode side and in contact with the negative electrode and contains a supporting electrolyte of the negative electrode and a solvent present on the negative electrode side. The negative electrode-side ion-conducting medium is preferably a non-aqueous electrolytic solution.

The supporting electrolyte of the negative electrode is not particularly limited, and for example, alkali metal salts are preferred, and lithium salts are more preferred. Examples of the lithium salt include LiPF₆, LiClO₄, LiAsF₆, LiBF₄, Li(CF₃SO₃), Li(CF₃SO₂)₂N [LiTFSI], Li(SO₂F)₂N [LiFSI], and LiN(C₂F₅SO₂)₂. These supporting electrolytes may be used singly or in combination of two or more. The concentration of the supporting electrolyte of the negative electrode in the negative electrode-side ion-conducting medium is preferably 0.1 to 3.0 mol/L, more preferably 0.5 to 2.0 mol/L, and even more preferably 0.5 to 1.0 mol/L.

The solvent present on the negative electrode side is not particularly limited, and examples thereof include organic solvents such as carbonate solvents, ester solvents, ether solvents, nitrile solvents, and ionic liquids. Examples of the carbonate solvent include cyclic carbonates such as ethylene carbonate, propylene carbonate, butylene carbonate, and vinylene carbonate; and chain carbonates such as dimethyl carbonate, diethyl carbonate, and ethyl methyl carbonate. Examples of the ester solvent include cyclic esters such as γ-butyrolactone and γ-valerolactone. Examples of the ether solvent include cyclic ethers such as tetrahydrofuran and 2-methyltetrahydrofuran; and chain ethers such as dimethoxyethane, ethylene glycol dimethyl ether, and polyethylene glycol-based ethers (e.g., polyethylene glycol monoalkyl ethers and polyethylene glycol dialkyl ethers). Examples of the nitrile solvent include acetonitrile, propionitrile, and 3-methoxypropionitrile. Examples of the ionic liquid include N-methyl-N-propylpiperidinium bis(trifluoromethanesulfonyl)imide, N,N,N-trimethyl-N-propylammonium bis(trifluoromethanesulfonyl)imide, and N,N-dimethyl-N-methyl-N-(2-methoxyethyl) ammonium bis(trifluoromethylsulfonyl)imide. These organic solvents may be used singly or in combination of two or more.

The ion-conducting medium used in the present invention preferably further contains a silane compound as an additive at least on the positive electrode side (for example, the ion-conducting medium includes a positive electrode-side ion-conducting medium further containing a silane compound as an additive on the positive electrode side). This increases the amount of ammonium ions produced. The ion-conducting medium may further contain a silane compound as an additive on the negative electrode side (for example, the ion-conducting medium may include a negative electrode-side ion-conducting medium further containing a silane compound as an additive on the negative electrode side). Examples of the silane compound include trialkylsilane compounds and their halides. The trialkylsilane compound preferably has a linear or branched alkyl group having 1 to 8 carbon atoms (more preferably 1 to 4 carbon atoms). Examples of the halide of the trialkylsilane compound include a compound in which the hydrogen atom bonded to the silicon atom of the trialkylsilane compound is substituted with a halogen atom such as F, Cl, Br, and I, for example, chlorotrimethylsilane, chlorotriethylsilane, and chlorotripropylsilane. These silane compounds may be used singly or in combination of two or more. From the viewpoint of increasing the amount of ammonium ions produced, the concentration of the silane compound in the ion-conducting medium (for example, the positive electrode-side ion-conducting medium and/or the negative electrode-side ion-conducting medium) is preferably 0.5 to 7.5 mol/L, more preferably 0.8 to 3 mol/L, and even more preferably 1 to 2 mol/L.

Among such ion-conducting media, an ion-conducting medium containing both a positive electrode-side ion-conducting medium containing LiFSI as the supporting electrolyte of the positive electrode and containing ether as the solvent present on the positive electrode side and a negative electrode-side ion-conducting medium containing LiFSI as the supporting electrolyte of the negative electrode and containing ether as the solvent present on the negative electrode side is more preferred, and an ion-conducting medium in which both the ether as the solvent present on the positive electrode side and the ether as the solvent present on the negative electrode side are the polyethylene glycol-based ethers is even more preferred, from the viewpoint of further increasing the electric capacity, energy density, and the amount of ammonium ions produced.

### (Separator)

The nitrogen battery of the present invention preferably comprises a separator between the positive electrode and the negative electrode. The separator separates the ion-conducting medium (e.g., the positive electrode-side ion-conducting medium) in contact with the positive electrode and the ion-conducting medium (e.g., the negative electrode-side ion-conducting medium) in contact with the negative electrode to play a role in preventing them from mixing. The separator is not particularly limited as long as it has a composition that is durable for use in a nitrogen battery, and examples thereof include solid electrolytes, polymer nonwoven fabrics such as polypropylene nonwoven fabric and polyphenylene sulfide nonwoven fabric, and olefinic resin microporous films such as polypropylene microporous films. These separators may be used singly or in combination of two or more. Among these separators, a solid electrolyte is preferred, and a solid electrolyte that conducts alkali metal ions (more preferably lithium ions) is more preferred, from the viewpoint that the concentration of LiFSI on the positive electrode side in the ion-conducting medium can be increased, and the electric capacity and energy density are improved.

Examples of the solid electrolyte include Li₂O—Al₂O₃—SiO₂—P₂O₅—TiO₂—GeO₂-based glass ceramics, solid electrolytes described in Japanese Unexamined Patent Application Publication No. 2009-122991 (e.g., garnet-type oxide Li₅₊ₓLa₃(Zrₓ, Nb₂₋ₓ)O₁₂ (1.4≤X<2), garnet-type oxide Li₇La₃Zr₂O₁₂, garnet-type oxide Li₇ALa₃Nb₂O₁₂ (A=Ca, Sr, Ba), glass ceramics Li_{1.5}Al_{0.5}Ge_{1.5}(PO₄)₃ [LAGP]). These solid electrolytes are useful as solid electrolytes that conduct lithium ions.

### (Nitrogen Battery)

The nitrogen battery of the present invention comprises the positive electrode, the negative electrode, and the ion-conducting medium, and the positive electrode and the negative electrode are arranged to face each other. The ion-conducting medium preferably includes one (e.g., the positive electrode-side ion-conducting medium) in contact with the positive electrode and one (e.g., the negative electrode-side ion-conducting medium) in contact with the negative electrode, and the ion-conducting medium in contact with the positive electrode and the ion-conducting medium in contact with the negative electrode are more preferably separated by the separator disposed between the positive electrode and the negative electrode.

In the nitrogen battery of the present invention, a space for introducing nitrogen is preferably provided above the positive electrode (on the side opposite to the surface facing the negative electrode). Furthermore, when the nitrogen battery of the present invention comprises the separator, the positive electrode is preferably pressed against the separator from above it (on the side opposite to the surface facing the negative electrode) by a pressing member such as a spring.

In the nitrogen battery of the present invention, the components of the ion-conducting medium in contact with the positive electrode and the ion-conducting medium in contact with the negative electrode, other than LiFSI as the supporting electrolyte of the positive electrode and ether as the solvent present on the positive electrode side, may have the same configuration or different configurations.

When the negative electrode is lithium metal, etc., the negative electrode and the separator (particularly the solid electrolyte) may be directly bonded if the separator (particularly the solid electrolyte) is stable with respect to the negative electrode.

The shape of the nitrogen battery of the present invention is not particularly limited, and examples thereof include a coin type, a button type, a sheet type, a laminated type, a cylindrical type, a flat type, and a rectangular type. The nitrogen battery of the present invention can be applied to a large-sized nitrogen battery used in an electric vehicle or the like.

In the nitrogen battery of the present invention, discharge and the nitrogen reduction reaction at the positive electrode proceed by bringing nitrogen into contact with the positive electrode while passing a current between the positive electrode and the negative electrode. In the nitrogen battery of the present invention, since the ion-conducting medium contains LiFSI as at least the supporting electrolyte of the positive electrode and ether as a solvent present at least on the positive electrode side is used as an ion-conducting medium, the plateau potential (potential in the region where the discharge potential is flat) becomes high, as a result, the electric capacity and energy density increase, and the amount of nitrogen reduction reaction products (e.g., silylamine, lithium nitride) produced also increases. The initial open circuit voltage is also high at 3.0 V or higher, preferably 3.3 V or higher. Particularly, when Fe is used as the transition metal, the initial open circuit voltage is 3.6 V or higher.

### [Fuel Synthesis Apparatus and Fuel Synthesis Method]

The fuel synthesis apparatus and the fuel synthesis method of the present invention are an apparatus and method using the nitrogen battery of the present invention, which make it possible to obtain as fuel ammonia generated by treating with water a nitrogen reduction reaction product (e.g., silylamine, lithium nitride) obtained after operation of the nitrogen battery. Ammonia is generally synthesized at high temperature and high pressure, but ammonia can be obtained at ordinary temperature and ordinary pressure by using the fuel synthesis apparatus of the present invention and/or employing the fuel synthesis method of the present invention. Specifically, the nitrogen battery of the present invention is discharged at ordinary temperature and ordinary pressure while introducing nitrogen to generate the nitrogen reduction reaction product, the ion-conducting medium containing the nitrogen reduction reaction product is taken out from the nitrogen battery after discharge, and the ion-conducting medium is treated with water to hydrolyze the nitrogen reduction reaction product, thereby obtaining ammonia extracted in water.

### EXAMPLES

Hereinafter, the present invention will be described more specifically based on Examples and Comparative Examples, but the present invention is not limited to the following Examples.

### Example 1

### <Production of Evaluation Cell (Nitrogen Battery)>

Anhydrous iron chloride (FeCl₂) and 2,5-dihydroxyterephthalic acid (dobdc) were added to dimethylformamide (DMF), and a synthesis reaction was performed under reflux conditions at 120° C. The obtained reaction product was washed with ethanol, then vacuum-dried at 120° C. to obtain iron 2,5-dihydroxyterephthalate (Fe₂(dobdc)) under an argon atmosphere. 50% by mass of the Fez (dobdc) as a positive electrode catalyst, 45% by mass of carbon black (Ketjenblack manufactured by Lion Specialty Chemicals Co., Ltd.) as a conductive auxiliary agent, and 5% by mass of polytetrafluoroethylene (PTFE) as a binder were mixed, the obtained mixture was formed into a sheet shape, then punched into a disk shape (17 mm diameter), and this was press-bonded onto a SUS mesh to be used as a positive electrode. A lithium metal plate was used as the negative electrode. A Lit-conductive solid electrolyte sheet (LICGC™AG-01 manufactured by OHARA Inc.) having a material composition of Li₂O—Al₂O₃—SiO₂—P₂O₅—TiO₂—GeO₂ was used as a separator for preventing mixing of the positive electrode side electrolytic solution and the negative electrode side electrolytic solution (ion-conducting medium). As a positive electrode side electrolytic solution (positive electrode-side ion-conducting medium), an electrolytic solution prepared by dissolving lithium bis(fluorosulfonyl)imide (LiFSI) as a supporting electrolyte at a concentration of 1.0 mol/L and chlorotrimethylsilane (TMSCl) as an additive at a concentration of 0.5 mol/L in tetraethylene glycol dimethyl ether (G4) solvent was used. As a negative electrode side electrolytic solution (negative electrode-side ion-conducting medium), an electrolytic solution prepared by dissolving LiFSI as a supporting electrolyte at a concentration of 1.0 mol/L in G4 solvent was used.

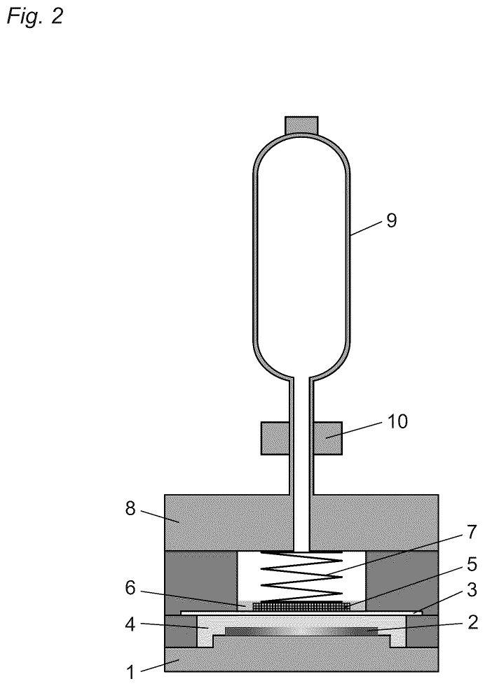

Using these, an evaluation cell (nitrogen battery) shown in FIG. 2 was produced. Specifically, a negative electrode 2 was placed on a negative electrode current collector 1, a separator 3 was placed thereon at a predetermined interval, and 1.5 ml of a negative electrode side electrolytic solution 4 was injected between the negative electrode 2 and the separator 3. A positive electrode 5 was placed on the separator 3, and 0.4 ml of a positive electrode side electrolytic solution 6 was poured so that the positive electrode 5 was completely immersed. The positive electrode 5 was pressed with a SUS spring 7 and fixed on the separator 3, and a positive electrode current collector 8 and a gas cylinder 9 were installed.

### <Discharge Test>

The produced evaluation cell (nitrogen battery) was set in a charge/discharge device (manufactured by Aska Electronic Co., Ltd., model name 5V/100MA), nitrogen gas was introduced into the space above the positive electrode 5 at a pressure of 0.05 MPa, a current was passed between the positive electrode 5 and the negative electrode 2 at a current density of 0.05 mA/cm² at a temperature of 25° C., and discharge was performed until the discharge voltage reached 0.5 V.

### Example 2

An evaluation cell (nitrogen battery) was produced in the same manner as in Example 1 except that the concentration of TMSC1 in the positive electrode side electrolytic solution was changed to 1.0 mol/L, and a discharge test was performed in the same manner as in Example 1 except that discharge was performed until the discharge voltage reached 1.0 V.

### Example 3

An evaluation cell (nitrogen battery) was produced in the same manner as in Example 1 except that the concentration of LiFSI in the positive electrode side electrolytic solution was changed to 0.5 mol/L, the solvent of the negative electrode side electrolytic solution was changed to a mixed solvent of 30 vol % ethylene carbonate (EC) and 70 vol % diethyl carbonate (DEC), and the supporting electrolyte of the negative electrode side electrolytic solution was changed to lithium bis(trifluoromethanesulfonyl)imide (LiTFSI), and a discharge test was performed in the same manner as in Example 1 except that the current density was changed to 0.15 mA/cm².

### Example 4

An evaluation cell (nitrogen battery) was produced in the same manner as in Example 3, and a discharge test was performed in the same manner as in Example 3 except that the current density was changed to 0.05 mA/cm².

### Example 5

An evaluation cell (nitrogen battery) was produced in the same manner as in Example 4 except that the positive electrode was changed to a carbon electrode containing no catalyst (carbon black/PTFE=95% by mass/5% by mass), and a discharge test was performed in the same manner as in Example 4.

### Example 6

An evaluation cell (nitrogen battery) was produced in the same manner as in Example 4 except that TMSCl was not added to the positive electrode side electrolytic solution, and a discharge test was performed in the same manner as in Example 4 except that the space above the positive electrode 5 was changed to a dry air atmosphere (dew point: −39° C., moisture content: 144 ppm or less).

### Example 7

An evaluation cell (nitrogen battery) was produced in the same manner as in Example 4 except that TMSCl was not added to the positive electrode side electrolytic solution, and a discharge test was performed in the same manner as in Example 4 except that discharge was performed until the discharge voltage reached 1.0 V.

### Comparative Example 1

An evaluation cell (nitrogen battery) was produced in the same manner as in Example 4 except that the supporting electrolyte of the positive electrode side electrolytic solution was changed to lithium nitrate (LiNO₃), and a discharge test was performed in the same manner as in Example 4.

### Comparative Example 2

An evaluation cell (nitrogen battery) was produced in the same manner as in Example 6 except that the supporting electrolyte of the positive electrode side electrolytic solution was changed to LiTFSI, and a discharge test was performed in the same manner as in Example 6.

### Comparative Example 3

An evaluation cell (nitrogen battery) was produced in the same manner as in Example 4 except that the solvent of the positive electrode side electrolytic solution was changed to a mixed solvent of 30 vol % ethylene carbonate (EC), 40 vol % dimethyl carbonate (DMC), and 30 vol % ethyl methyl carbonate, and the concentration of LiFSI in the positive electrode side electrolytic solution was changed to 1.1 mol/L, and a discharge test was performed in the same manner as in Example 4.

### Comparative Example 4

An evaluation cell (nitrogen battery) was produced in the same manner as in Example 4 except that the supporting electrolyte of the positive electrode side electrolytic solution was changed to LiTFSI, and a discharge test was performed in the same manner as in Example 4.

### Comparative Example 5

An evaluation cell (nitrogen battery) was produced in the same manner as in Comparative Example 4 except that the positive electrode was changed to a carbon electrode containing no catalyst (carbon black/PTFE=95% by mass/5% by mass), and a discharge test was performed in the same manner as in Comparative Example 4.

### Comparative Example 6

An evaluation cell (nitrogen battery) was produced in the same manner as in Example 4 except that the supporting electrolyte of the positive electrode side electrolytic solution was changed to lithium hexafluorophosphate (LiPF₆), and a discharge test was performed in the same manner as in Example 4.

### Example 8

### <Production of Evaluation Cell (Nitrogen Battery)>

An evaluation cell (nitrogen battery) shown in FIG. 2 was produced in the same manner as in Example 1 except that the following were used. Specifically, anhydrous iron chloride (FeCl₂) and 2,5-dihydroxyterephthalic acid (dobdc) were added to dimethylformamide (DMF), and a synthesis reaction was performed under reflux conditions at 120° C. The obtained reaction product was washed with DMF and ethanol, then vacuum-dried at 120° C. to obtain iron 2,5-dihydroxyterephthalate (Fe₂ (dobdc)) in an air atmosphere. 50% by mass of the Fe₂ (dobdc) as a positive electrode catalyst, 45% by mass of carbon black (Ketjenblack manufactured by Lion Specialty Chemicals Co., Ltd.) as a conductive auxiliary agent, and 5% by mass of polytetrafluoroethylene (PTFE) as a binder were mixed, the obtained mixture was formed into a sheet shape, then punched into a disk shape (17 mm diameter), and this was press-bonded onto a SUS mesh to be used as a positive electrode. A lithium metal plate was used as the negative electrode. A Lit-conductive solid electrolyte sheet (LICGC™AG-01 manufactured by OHARA Inc.) having a material composition of Li₂O—Al₂O₃—SiO₂—P₂O₅—TiO₂—GeO₂ was used as a separator for preventing mixing of the positive electrode side electrolyte and the negative electrode side electrolyte (ion-conducting medium). As the positive electrode side electrolyte (positive electrode-side ion-conducting medium), an electrolytic solution prepared by dissolving lithium bis(fluorosulfonyl)imide (LiFSI) as a supporting electrolyte at a concentration of 1.0 mol/L and chlorotrimethylsilane (TMSCl) as an additive at a concentration of 0.5 mol/L in tetraethylene glycol dimethyl ether (G4) solvent was used. As the negative electrode side electrolyte (negative electrode-side ion-conducting medium), an electrolytic solution prepared by dissolving lithium bis(trifluoromethanesulfonyl)imide (LiTFSI) as a supporting electrolyte at a concentration of 1.0 mol/L in a solvent containing ethylene carbonate (EC) and diethyl carbonate (DEC) at a volume ratio of 50:50 was used.

### <Discharge Test>

The produced evaluation cell (nitrogen battery) was set in a charge/discharge device (manufactured by Aska Electronic Co., Ltd., model name 5V/100MA), nitrogen gas or argon gas was introduced into the space above the positive electrode 5 at a pressure of 0.05 MPa, a current was passed between the positive electrode 5 and the negative electrode 2 at a current density of 0.10 mA/cm² at a temperature of 25° C., and discharge was performed until the discharge voltage reached 1.0 V.

### Example 9

An evaluation cell (nitrogen battery) was produced in the same manner as in Example 8 except that nickel acetate (Ni(CH₃COO)₂) was used instead of anhydrous iron chloride (FeCl₂), and a discharge test was performed in the same manner as in Example 8.

### Example 10

An evaluation cell (nitrogen battery) was produced in the same manner as in Example 8 except that cobalt acetate (Co(CH₃COO)₂) was used instead of anhydrous iron chloride (FeCl₂), and a discharge test was performed in the same manner as in Example 8.

### Example 11

An evaluation cell (nitrogen battery) was produced in the same manner as in Example 8 except that manganese acetate (Mn(CH₃COO)₂) was used instead of anhydrous iron chloride (FeCl₂), and a discharge test was performed in the same manner as in Example 8.

### <Calculation of Electric Capacity and Energy Density>

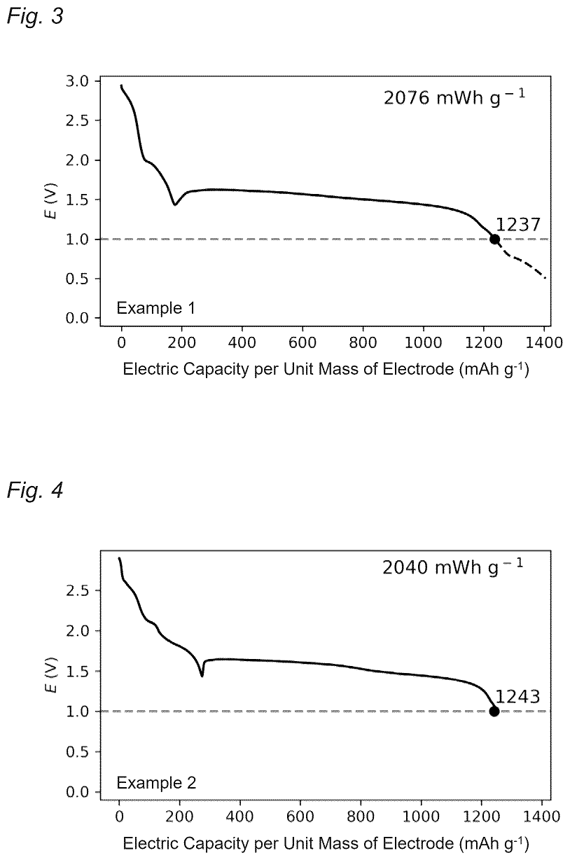

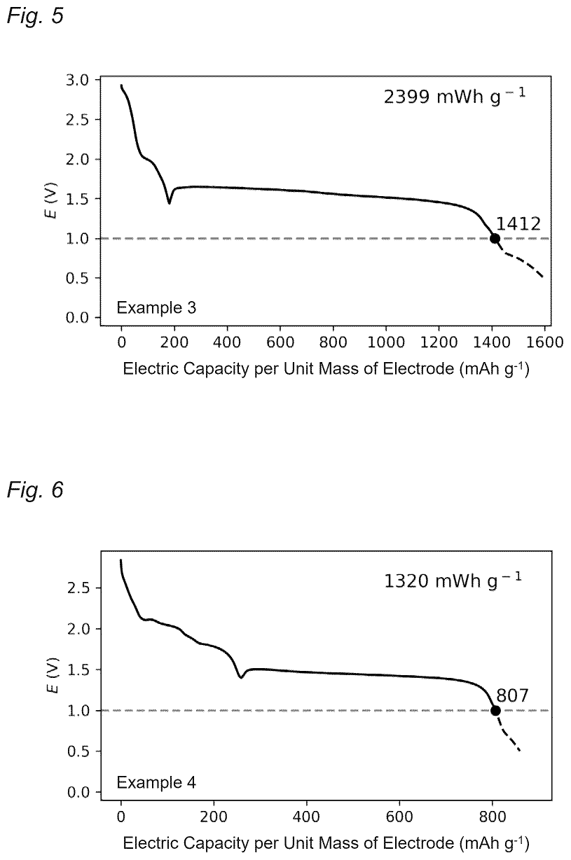

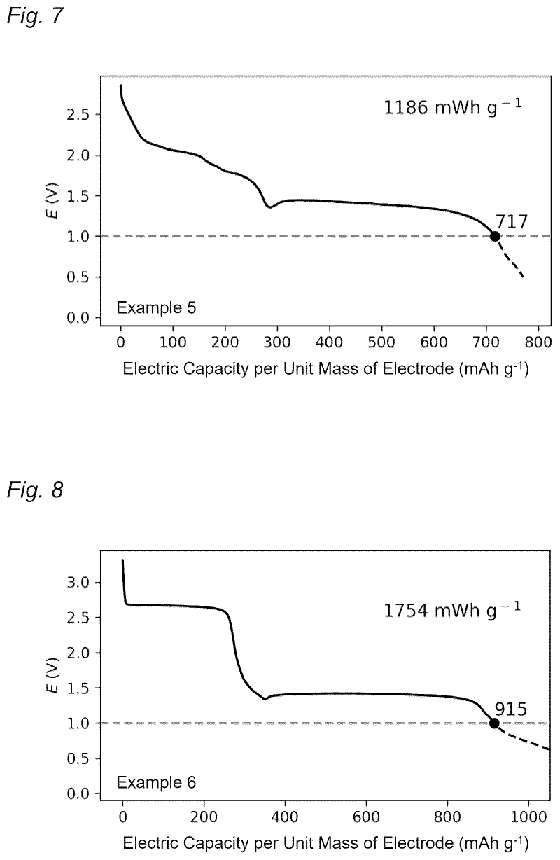

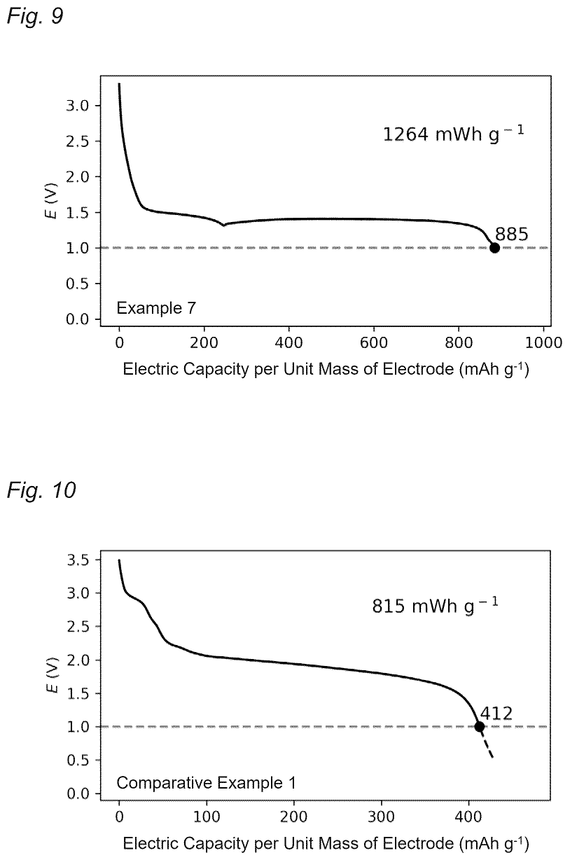

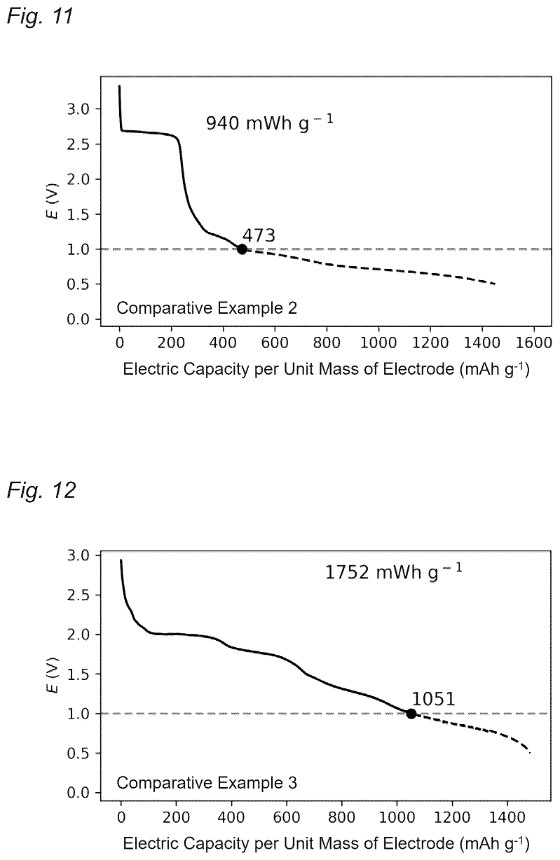

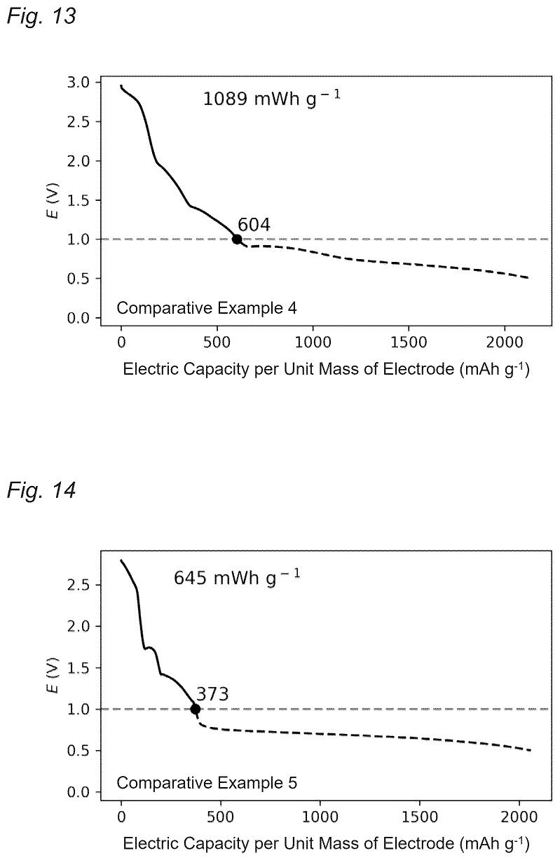

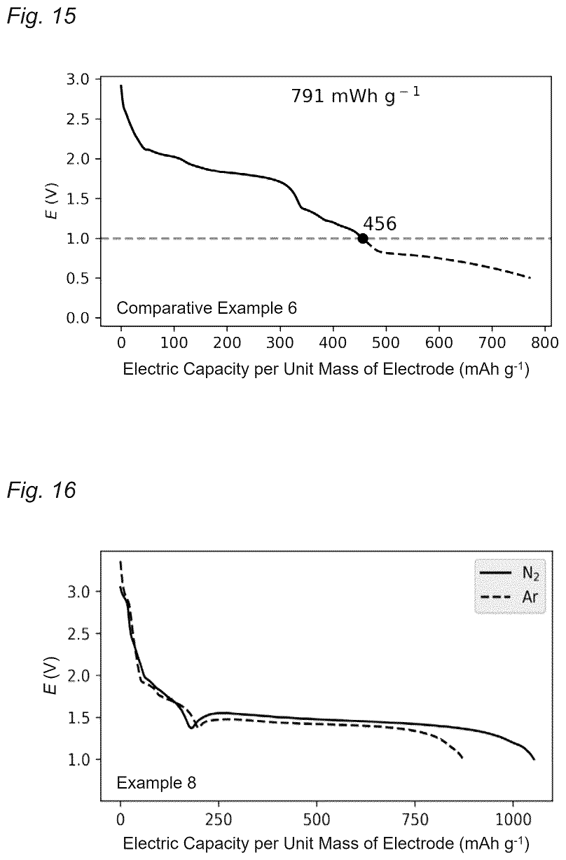

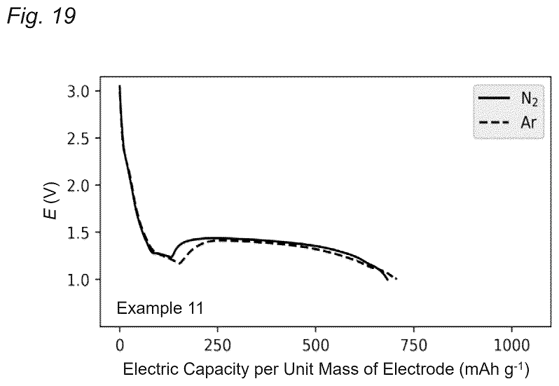

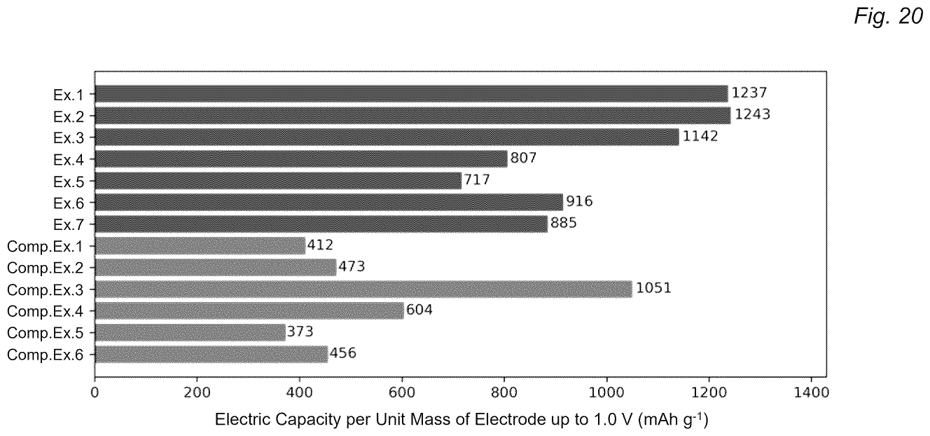

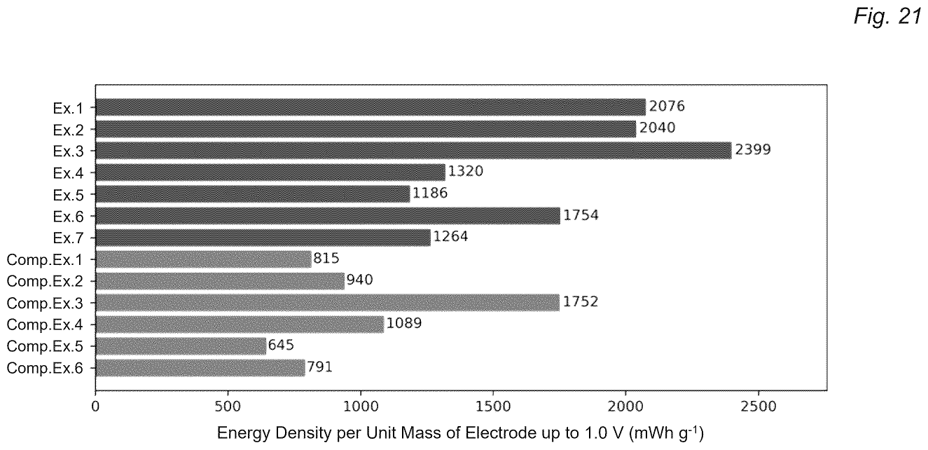

Based on the discharge test results for the evaluation cells (nitrogen batteries) produced in Examples and Comparative Examples, the relationship (discharge curve) between the electric capacity per unit mass of the electrode (positive electrode) and the discharge voltage was determined. The results are shown in FIGS. 3 to 19. Based on the discharge curves shown in FIGS. 3 to 19, the electric capacity and energy density per unit mass of the electrode (positive electrode) until the discharge voltage reached 1.0 V were determined. The results are shown in Tables 1 and 2 and FIGS. 20 to 22.

### <Quantification of Ammonium Ions>

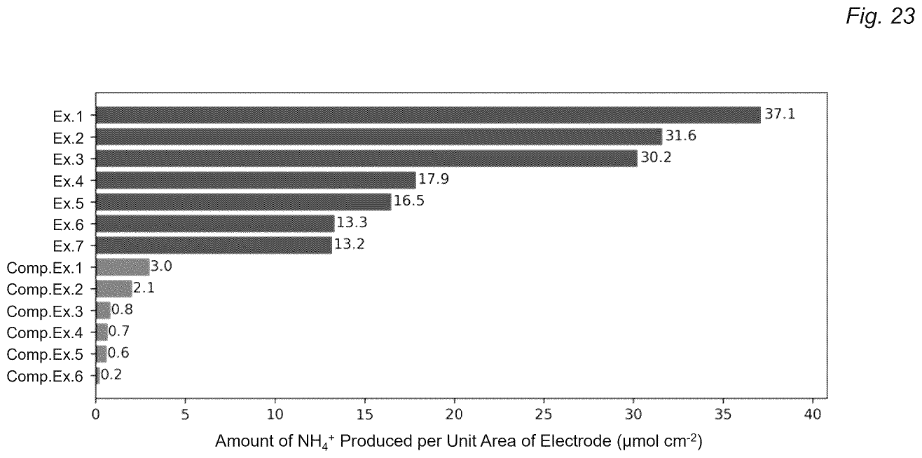

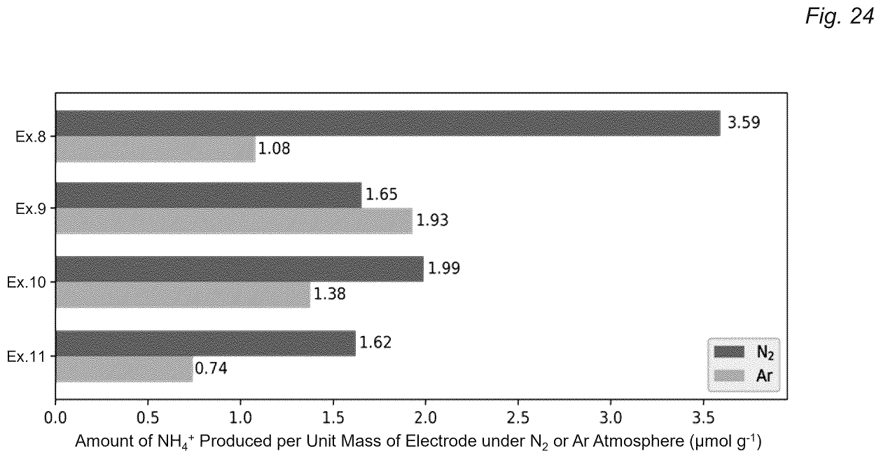

5 ml of a 2 mol/L H₂SO₄ aqueous solution was added to the electrode (positive electrode) taken out from the evaluation cell (nitrogen battery) after the discharge test. The recovered aqueous solution was filtered using a syringe filter with a pore size of 0.2 μm, the filtrate was diluted 100-fold, then ammonium ions were quantified using an ion chromatograph (ICS-5000⁺ manufactured by Thermo Fisher Scientific K.K.), and the amount of ammonium ions produced per unit area or unit mass of the electrode (positive electrode) was calculated. The results are shown in Tables 1 and 2 and FIGS. 23 and 24.

### <X-Ray Absorption Fine Structure (XAFS) Spectrum Measurement>

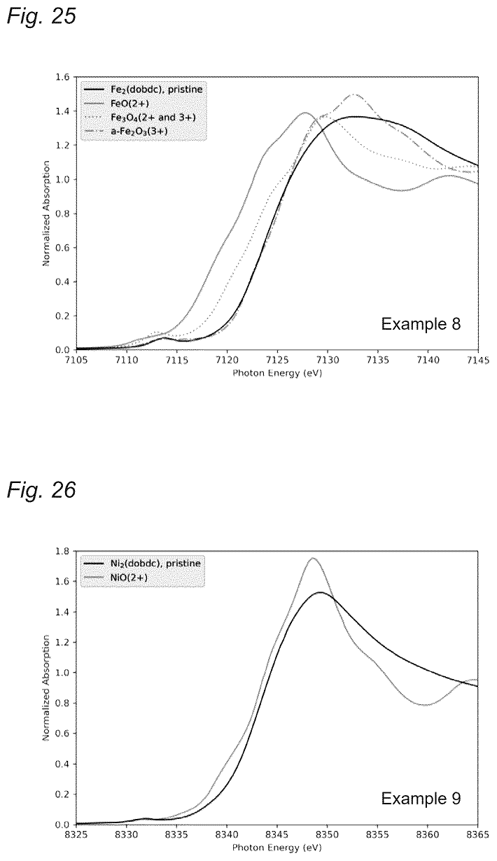

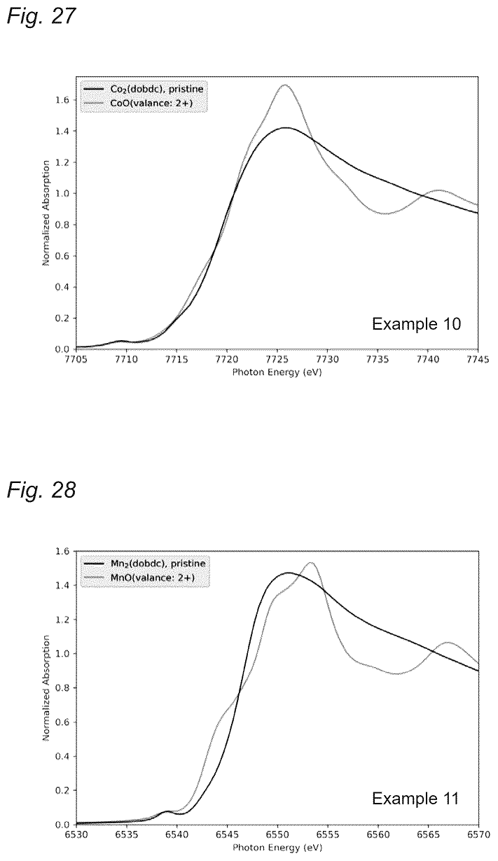

The K-edge XAFS spectra of the transition metals of the positive electrode catalysts after the discharge test were measured by the transmission method using the Toyota beamline BL33XU of Spring-8. Specifically, the positive electrode containing the catalyst was taken out from the evaluation cell after the discharge test, and a sample for measurement was prepared by covering the positive electrode with Kapton tape in a glove box. Using this sample for measurement, the K-edge XAFS spectra of the transition metals in the catalyst were measured by step scan under atmospheric non-exposure conditions for 10 min/sample. The results are shown in FIGS. 25 to 28. The obtained XAFS spectra were normalized and background-removed using Athena of Demeter, an analysis software for XAFS. FIG. 25 also shows the K-edge XAFS spectra of Fe in FeO, Fe₃O₄, and α-Fe₂O₃, FIG. 26 shows the K-edge XAFS spectrum of Ni in NiO, FIG. 27 shows the K-edge XAFS spectrum of Co in Coo, and FIG. 28 shows the K-edge XAFS spectrum of Mn in MnO.

As shown in FIG. 25, it was found that Fe in the positive electrode catalyst prepared in Example 8 was in a trivalent state because the K-edge XAFS spectrum was close to the K-edge XAFS spectrum of trivalent Fe in α-Fe₂O₃. As shown in FIG. 26, it was found that Ni in the positive electrode catalyst prepared in Example 9 was in a divalent state because the K-edge XAFS spectrum was close to the K-edge XAFS spectrum of divalent Ni in NiO. Furthermore, as shown in FIG. 27, it was found that Co in the positive electrode catalyst prepared in Example 10 was in a divalent state because the K-edge XAFS spectrum was close to the K-edge XAFS spectrum of divalent Co in CoO. As shown in FIG. 28, it was found that Mn in the positive electrode catalyst prepared in Example 11 was in a divalent state because the K-edge XAFS spectrum was close to the K-edge XAFS spectrum of divalent Mn in MnO.

TABLE 1

| | Positive Electrode | | | | | Negative Electrode | | |
|---|---|---|---|---|---|---|---|---|
| | | Electrolytic Solution | | | | Electrolytic Solution | | |
| | | (Ion-Conducting Medium) | | | | (Ion-Conducting Medium) | | |
| | | Supporting | | | | Supporting | | |
| | | Electrolyte | | | | Electrolyte | | |
| | | | Conc. | | | | Conc. | |
| | Catalyst | Type | [mol/L] | Solvent | Additive | Type | [mol/L] | Solvent |
| Ex. 1 | Fe₂(dobdc) | LiFSI | 1.0 | G4 | 0.5M TMSCI | LiFSI | 1.0 | G4 |
| Ex. 2 | Fe₂(dobdc) | LiFSI | 1.0 | G4 | 1.0M TMSCI | LiFSI | 1.0 | G4 |
| Ex. 3 | Fe₂(dobdc) | LiFSI | 0.5 | G4 | 0.5M TMSCI | LiTFS | 1.0 | EC + DEC |
| Ex. 4 | Fe₂(dobdc) | LiFSI | 0.5 | G4 | 0.5M TMSCI | LiTFSI | 1.0 | EC + DEC |
| Ex. 5 | Carbon | LiFSI | 0.5 | G4 | 0.5M TMSCI | LiTFSI | 1.0 | EC + DEC |
| Ex. 6 | Fe₂(dobdc) | LiFSI | 0.5 | G4 | — | LiTFSI | 1.0 | EC + DEC |
| Ex. 7 | Fe₂(dobdc) | LiFSI | 0.5 | G4 | — | LiTFSI | 1.0 | EC + DEC |
| Comp. Ex. 1 | Fe₂(dobdc) | LiNO₃ | 0.5 | G4 | 0.5M TMSCI | LiTFSI | 1.0 | EC + DEC |
| Comp. Ex. 2 | Fe₂(dobdc) | LiTFSI | 0.5 | G4 | — | LiTFSI | 1.0 | EC + DEC |
| Comp. Ex. 3 | Fe₂(dobdc) | LiFSI | 1.1 | EC + | 0.5M TMSCI | LiTFSI | 1.0 | EC + DEC |
| | | | | DMC + | | | | |
| | | | | EMC | | | | |
| Comp. Ex. 4 | Fe₂(dobdc) | LiTFSI | 0.5 | G4 | 0.5M TMSCI | LiTFSI | 1.0 | EC + DEC |
| Comp. Ex. 2 | Carbon | LiTFSI | 0.5 | G4 | 0.5M TMSCI | LiTFSI | 1.0 | EC + DEC |
| Comp. Ex. 6 | Fe₂(dobdc) | LiPF₆ | 0.5 | G4 | 0.5M TMSCI | LiTFSI | 1.0 | EC + DEC |

| | Positive | | Discharge | Electric | Energy | Amount |
|---|---|---|---|---|---|---|
| | Electrode | Current | Cutoff | Capacity | Density | of NH₄⁺ |
| | Side- | Density | Voltage | [mAh/g] | [mWh/g] | Produced |
| | Atmosphere | [mA/cm²] | [V] | (up to 1.0 V) | (up to 1.0 V) | [μmol/cm²] |
| Ex. 1 | N₂ | 0.05 | 0.5 | 1237 | 2076 | 37.10 |
| Ex. 2 | N₂ | 0.05 | 1.0 | 1243 | 2040 | 31.60 |
| Ex. 3 | N₂ | 0.15 | 0.5 | 1142 | 2399 | 30.23 |
| Ex. 4 | N₂ | 0.05 | 0.5 | 807 | 1320 | 17.86 |
| Ex. 5 | N₂ | 0.05 | 0.5 | 717 | 1186 | 16.49 |
| Ex. 6 | Dry Air | 0.05 | 0.5 | 916 | 1754 | 13.33 |
| Ex. 7 | N₂ | 0.05 | 1.0 | 885 | 1264 | 13.19 |
| Comp. Ex. 1 | N₂ | 0.05 | 0.5 | 412 | 815 | 3.02 |
| Comp. Ex. 2 | Dry Air | 0.05 | 0.5 | 473 | 940 | 2.06 |
| Comp. Ex. 3 | N₂ | 0.05 | 0.5 | 1051 | 1752 | 0.84 |
| Comp. Ex. 4 | N₂ | 0.05 | 0.5 | 604 | 1089 | 0.67 |
| Comp. Ex. 2 | N₂ | 0.05 | 0.5 | 373 | 645 | 0.63 |
| Comp. Ex. 6 | N₂ | 0.05 | 0.5 | 456 | 791 | 0.23 |

As shown in Table 1 and FIGS. 20, 21, and 23, it was found that when an electrolytic solution containing LiFSI and G4 solvent was used as at least the positive electrode side electrolytic solution (Examples 1 to 7), the electric capacity, energy density, and amount of ammonium ions produced were all increased as compared with the case where neither the positive electrode side nor the negative electrode side electrolytic solution contained LiFSI (Comparative Examples 1 to 2 and 4 to 6). The reason for this would be considered that, when an electrolytic solution containing LiFSI and G4 solvent was used as the positive electrode side electrolytic solution, a plateau region where the discharge curve is flat exists in a wide range, as shown in FIGS. 3 to 9, whereas when neither the positive electrode side nor the negative electrode side electrolytic solution contains LiFSI (Comparative Examples 1 to 2 and 4 to 6), there is no plateau region or the range of the plateau region is narrow, as shown in FIGS. 10, 11, and 13 to 15.

On the other hand, it was found that when an electrolytic solution containing LiFSI and a carbonate solvent was used as the positive electrode side electrolytic solution (Comparative Example 3), the electric capacity and energy density increased as compared with the case where neither the positive electrode side nor the negative electrode side electrolytic solution contained LiFSI (Comparative Examples 1 to 2 and 4 to 6), but the amount of ammonium ions produced did not increase and was significantly decreased as compared with the case where an electrolytic solution containing LiFSI and G4 solvent was used as at least the positive electrode side electrolytic solution (Examples 1 to 7).

It was also found that as the LiFSI concentration in the positive electrode side electrolytic solution increased, the electric capacity, energy density, and amount of ammonium ions produced all increased (comparison between Examples 1 and 2 and Examples 4 to 7).

Furthermore, it was found that when TMSCl was added to the positive electrode side electrolytic solution (Examples 1 to 5), the amount of ammonium ions produced increased as compared with the case where it was not added (Examples 6 and 7).

It was also found that even when carbon was used as the positive electrode, when LiFSI was used as the supporting electrolyte of the positive electrode side electrolytic solution (Example 5), the electric capacity, energy density, and amount of ammonium ions produced all increased as compared with the case where LiTFSI was used (Comparative Example 5).

Furthermore, it was found that even when dry air was introduced into the positive electrode, when LiFSI was used as the supporting electrolyte of the positive electrode side electrolytic solution (Example 6), the electric capacity, energy density, and amount of ammonium ions produced all increased as compared with the case where LiTFSI was used (Comparative Example 2).

TABLE 2

| | Positive Electrode | | | | | Negative Electrode | | | |
|---|---|---|---|---|---|---|---|---|---|
| | | Electrolytic Solution | | | | Electrolytic Solution | | | |
| | | (Ion-Conducting Medium) | | | | (Ion-Conducting Medium) | | | |
| | | Supporting | | | | Supporting | | | Positive |
| | | Electrolyte | | | | Electrolyte | | | Electrode |
| | | | Conc. | | | | Conc. | | Side- |
| | Catalyst | Type | [mol/L] | Solvent | Additive | Type | [mol/L] | Solvent | Atmosphere |
| Ex. 8 | Fe₂(dobdc) | LiFSI | 1.0 | G4 | 0.5M TMSCI | LiTFSI | 1.0 | EC + DEC | N₂ |
| | | | | | | | | | Ar |
| Ex. 9 | Ni₂(dobdc) | LiFSI | 1.0 | G4 | 0.5M TMSCI | LiTFSI | 1.0 | EC + DEC | N₂ |
| | | | | | | | | | Ar |
| Ex. 10 | Co₂(dobdc) | LiFSI | 1.0 | G4 | 0.5M TMSCI | LiTFSI | 1.0 | EC + DEC | N₂ |
| | | | | | | | | | Ar |
| Ex. 11 | Mn₂(dobdc) | LiFSI | 1.0 | G4 | 0.5M TMSCI | LiTFSI | 1.0 | EC + DEC | N₂ |
| | | | | | | | | | Ar |

| | | | | | | Difference | |
|---|---|---|---|---|---|---|---|
| | | | Initial | | | in Amount | |
| | | Discharge | Open | Electric | Amount | of NH₄⁺ | |
| | Current | Cutoff | Circuit | Capacity | of NH₄⁺ | Produced | Valence of |
| | Density | Voltage | Voltage | [mAh/g] | Produced | (N₂—Ar) | Transition |
| | [mA/cm²] | [V] | [V] | (up to 1.0 V) | [mmol/g] | [mmol/g] | Metal |
| Ex. 8 | 0.10 | 1.0 | 3.66 | 1052.8 | 3.59 | 2.51 | 3 |
| | 0.10 | 1.0 | 3.66 | 740.5 | 1.08 | | |
| Ex. 9 | 0.10 | 1.0 | 3.31 | 846.0 | 1.65 | −0.28 | 2 |
| | 0.10 | 1.0 | 3.31 | 871.3 | 1.93 | | |
| Ex. 10 | 0.10 | 1.0 | 3.32 | 880.3 | 1.99 | 0.61 | 2 |
| | 0.10 | 1.0 | 3.32 | 698.4 | 1.38 | | |
| Ex. 11 | 0.10 | 1.0 | 3.30 | 743.9 | 1.62 | 0.88 | 2 |
| | 0.10 | 1.0 | 3.30 | 728.3 | 0.74 | | |

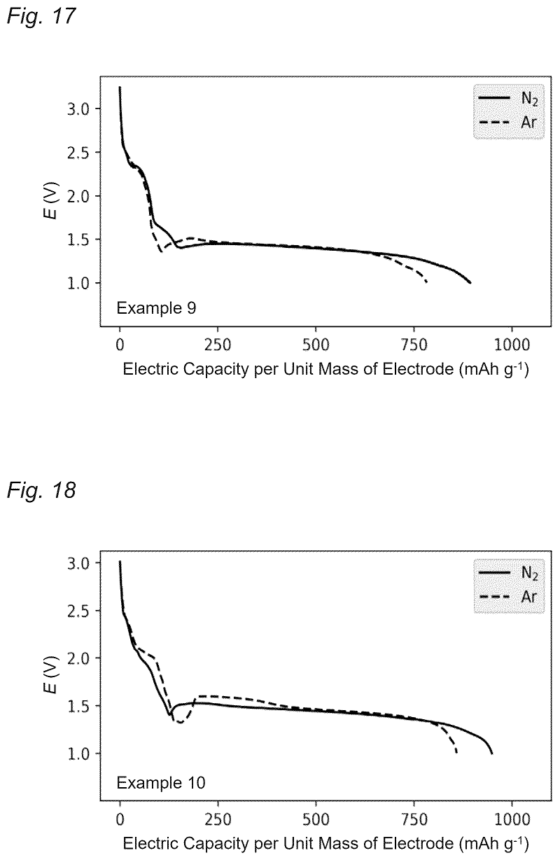

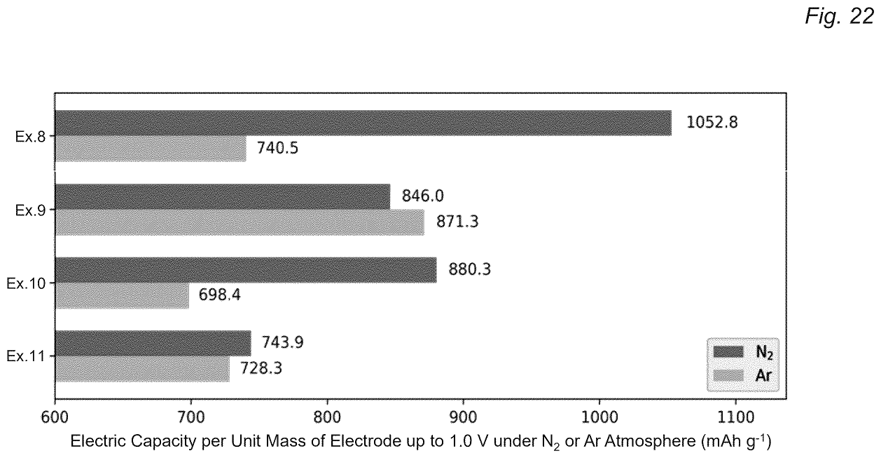

As shown in Table 2, FIGS. 22 and 24, it was found that even when any of the transition metals Fe, Ni, Co, and Mn was used (Examples 8 to 11), the nitrogen battery using nitrogen as the positive electrode active material showed high values of electric capacity and amount of ammonium ions produced, but when Fe was used (Example 8), particularly high values were shown as compared with the cases where Ni, Co, or Mn was used (Examples 9 to 11). This is considered to be because, as shown in Table 2, when Fe was used (Example 8), the difference between the amount of ammonium ions produced in a nitrogen atmosphere and the amount of ammonium ions produced in an argon atmosphere was larger than when Ni, Co, or Mn was used (Examples 9 to 11), so that the reduction reaction of nitrogen derived from nitrogen gas proceeded efficiently. The reasons why the reduction reaction of nitrogen derived from nitrogen gas proceeded efficiently when Fe was used are considered to be as follows: (1) when Fe was used, the plateau potential at which the discharge curve was flat was higher in the nitrogen atmosphere than in the argon atmosphere as shown in FIG. 16, whereas when Ni, Co, or Mn was used, the plateau potential in the nitrogen atmosphere was almost the same as that in the argon atmosphere, as shown in FIGS. 17 to 19; (2) when Fe was used, the plateau region was wider than when Ni, Co, or Mn was used, as is clear from a comparison between FIG. 16 and FIGS. 17 to 19; and (3) in the positive electrode catalyst, Ni, Co, and Mn were in a divalent state, whereas Fe was in a trivalent state, as shown in Table 2 and FIGS. 25 to 28, so that Fe becomes a nitrogen adsorption site (open metal site), whereby nitrogen derived from nitrogen gas is catalytically reduced.

As described above, according to the present invention, it is possible to obtain a nitrogen battery having high electric capacity and high energy density. Therefore, the nitrogen battery of the present invention is useful as a novel nitrogen battery that can be used as an energy device.

Since the fuel synthesis apparatus and fuel synthesis method of the present invention use such a nitrogen battery having high electric capacity and high energy density, they can efficiently reduce nitrogen, efficiently synthesize a nitrogen reduction reaction product, and obtain ammonia with high efficiency. Therefore, the fuel synthesis apparatus and fuel synthesis method of the present invention are useful as an apparatus and method capable of supplying ammonia as fuel.

### REFERENCE SIGNS LIST

1: negative electrode current collector
2: negative electrode
3: separator
4: negative electrode side electrolytic solution
5: positive electrode
6: positive electrode side electrolytic solution
7: spring
8: positive electrode current collector
9: gas cylinder
10: connection part

What is claimed is:

1. A nitrogen battery comprising:
a positive electrode using nitrogen as a positive electrode active material;
a negative electrode; and
an ion-conducting medium containing lithium bis(fluorosulfonyl)imide as at least a supporting electrolyte of the positive electrode, containing ether as a solvent present at least on a positive electrode side, and conducting alkali metal ions.

2. The nitrogen battery according to claim 1, wherein the ether as the solvent present on the positive electrode side is a polyethylene glycol-based ether.

3. The nitrogen battery according to claim 1, wherein the ion-conducting medium further contains a silane compound as an additive at least on the positive electrode side.

4. The nitrogen battery according to claim 2, wherein the ion-conducting medium further contains a silane compound as an additive at least on the positive electrode side.

5. The nitrogen battery according to claim 1, wherein
the ion-conducting medium includes a positive electrode-side ion-conducting medium present on the positive electrode side and in contact with the positive electrode and a negative electrode-side ion-conducting medium present on a negative electrode side and in contact with the negative electrode,
the positive electrode-side ion-conducting medium contains lithium bis(fluorosulfonyl)imide as a supporting electrolyte of the positive electrode and contains ether as a solvent present on the positive electrode side, and
the negative electrode-side ion-conducting medium contains lithium bis(fluorosulfonyl)imide as a supporting electrolyte of the negative electrode and contains ether as a solvent present on the negative electrode side.

6. The nitrogen battery according to claim 2, wherein
the ion-conducting medium includes a positive electrode-side ion-conducting medium present on the positive electrode side and in contact with the positive electrode and a negative electrode-side ion-conducting medium present on a negative electrode side and in contact with the negative electrode,
the positive electrode-side ion-conducting medium contains lithium bis(fluorosulfonyl)imide as a supporting electrolyte of the positive electrode and contains ether as a solvent present on the positive electrode side, and
the negative electrode-side ion-conducting medium contains lithium bis(fluorosulfonyl)imide as a supporting electrolyte of the negative electrode and contains ether as a solvent present on the negative electrode side.

7. The nitrogen battery according to claim 3, wherein
the ion-conducting medium includes a positive electrode-side ion-conducting medium present on the positive electrode side and in contact with the positive electrode and a negative electrode-side ion-conducting medium present on a negative electrode side and in contact with the negative electrode,
the positive electrode-side ion-conducting medium contains lithium bis(fluorosulfonyl)imide as a supporting electrolyte of the positive electrode and contains ether as a solvent present on the positive electrode side, and
the negative electrode-side ion-conducting medium contains lithium bis(fluorosulfonyl)imide as a supporting electrolyte of the negative electrode and contains ether as a solvent present on the negative electrode side.

8. The nitrogen battery according to claim 4, wherein
the ion-conducting medium includes a positive electrode-side ion-conducting medium present on the positive electrode side and in contact with the positive electrode and a negative electrode-side ion-conducting medium present on a negative electrode side and in contact with the negative electrode,
the positive electrode-side ion-conducting medium contains lithium bis(fluorosulfonyl)imide as a supporting electrolyte of the positive electrode and contains ether as a solvent present on the positive electrode side, and
the negative electrode-side ion-conducting medium contains lithium bis(fluorosulfonyl)imide as a supporting electrolyte of the negative electrode and contains ether as a solvent present on the negative electrode side.

9. The nitrogen battery according to claim 5, wherein both the ether as the solvent present on the positive electrode side and the ether as the solvent present on the negative electrode side are polyethylene glycol-based ethers.

10. The nitrogen battery according to claim 6, wherein both the ether as the solvent present on the positive electrode side and the ether as the solvent present on the negative electrode side are polyethylene glycol-based ethers.

11. The nitrogen battery according to claim 7, wherein both the ether as the solvent present on the positive electrode side and the ether as the solvent present on the negative electrode side are polyethylene glycol-based ethers.

12. The nitrogen battery according to claim 8, wherein both the ether as the solvent present on the positive electrode side and the ether as the solvent present on the negative electrode side are polyethylene glycol-based ethers.

13. The nitrogen battery according to claim 1, wherein the positive electrode includes an electrode catalyst having immobilized transition metal ions.

14. The nitrogen battery according to claim 13, wherein the electrode catalyst is a metal-organic framework containing transition metal ions and aromatic polycarboxylate ions.

15. The nitrogen battery according to claim 14, wherein the transition metal ions are Fe ions, and the aromatic polycarboxylate ions are aromatic dicarboxylate ions represented by the following formula (1): 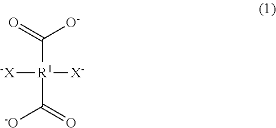
wherein R¹ represents a tetravalent organic group containing an aromatic ring, and X represents O or S.

16. The nitrogen battery according to claim 15, wherein at least a part of the Fe ions are trivalent Fe ions.

17. A fuel synthesis apparatus using the nitrogen battery according to claim 1, which obtains as fuel ammonia generated by treating with water a nitrogen reduction reaction product obtained after operation of the nitrogen battery.

18. A fuel synthesis method using the nitrogen battery according to claim 1, comprising obtaining as fuel ammonia generated by treating with water a nitrogen reduction reaction product obtained after operation of the nitrogen battery.
